(19) United States
(12) Patent Application Publication
(10) Pub. No.: US 2021/0345559 A1
(43) Pub. Date: Nov. 11, 2021

(54) METHOD FOR PLANTING AND PROCESSING HIGH-YIELD FORAGE IN HIGH ALTITUDE AREA

(71) Applicant: Sichuan Agricultural University, Cheng Du (CN)

(72) Inventors: Yanhong YAN, Cheng Du (CN); Wenyu YANG, Cheng Du (CN); Weiguo Liu, Cheng Du (CN); Qiyin XIAO, Cheng Du (CN); Dongming Chen, Cheng Du (CN); Xingjin Wen, Cheng Du (CN); Mei Xu, Cheng Du (CN); Jizhi Yang, Cheng Du (CN); Zhaochang Du, Cheng Du (CN); Guoqian Zhu, Cheng Du (CN)

(73) Assignee: Sichuan Agricultural University, Cheng Du (CN)

(21) Appl. No.: 17/038,225

(22) Filed: Sep. 30, 2020

(30) Foreign Application Priority Data
May 11, 2020 (CN) 202010393285.5

(51) Int. Cl. A01G 22/20; A01G 22/40; A01C 7/08

(52) U.S. Cl. CPC A01G 22/20; A01C 7/08; A01G 22/40

(57) ABSTRACT

The present application discloses a method for planting and processing high-yield forage in high altitude area, and belongs to the technical field of feed preparation in a high altitude area. The planting method of the present application comprises the steps of: intercropping maize and soybeans at an altitude of more than 3000 m, and the maize varieties include Demeiya No. 1 and Demeiya No. 3, the soybean varieties include Zhongdou No. 39 and Huachun No. 6. The planting method of the present application can realize the successful planting of maize and soybeans in a high altitude area (>3000 m), and can greatly improve the biological yield.

### CROSS REFERENCE TO RELATED APPLICATION

This application claims the priority of Chinese Patent Application No. 202010393285.5 entitled “Method for planting and processing high-yield forage in Tibetan Plateau” filed with China National Intellectual Property Administration on May 11, 2020, which is incorporated herein by reference in its entirety.

### TECHNICAL FIELD

The present application belongs to the technical field of feed preparation in high altitude area, especially relating to a method for planting and processing high-yield forage at an altitude of more than 3000 m.

### BACKGROUND ART

Ganzi and Aba are the key poverty-stricken areas in China, which are located in the eastern edge of the Tibetan Plateau, with a grassland area of 12.54 million hectares. Yaks are the local advantages and characteristic breeds. There are a large number of yaks with good quality. The average annual stock of yaks is more than 4 million, accounting for 30% of the country, and the yak industry is the leading industry on which the Tibetan ancestors depend for the social and economic development of the Tibetan area. However, the contradiction between the growth of forage and the seasonal demand for feed balance is very serious. Yak cannot get rid of the vicious circle of “full in summer, fat in autumn, thin in winter, and dead in spring”, and the loss of fat and death are extremely serious. The lack of feed in winter and spring is the basic reason of the poverty of herdsmen and the bottleneck that restricts the healthy and sustainable development of the yak industry. It is of great significance to effectively solve the problem of lack of yak forage in winter and spring in Tibetan areas, which is related to the herdsman's poverty alleviation, social stability and economic development. The existing methods of artificial planting forage and highland barley in Tibetan Plateau have low biological yield (30-37.5 t per hm² at an altitude of 2000 m-2500 m, and only 1.5-2 t above 3000 m). Maize can only be planted at an altitude below 2500 m with a wide planting but the harvest is low. Yaks depends on the grassland for survival in summer, but traditional forage planted in plateau in winter can not meet the demand for yak in winter and spring. At present, the problem of lack of yak forage in the Tibetan Plateau areas is still not effectively resolved.

### SUMMARY OF THE INVENTION

The purpose of the present application is to provide a method for planting and processing high-yield forage in high altitude area (>3000 m), such as in Tibetan Plateau. The planting method of the present application can realize the successful planting of maize and soybeans in high altitude area (>3000 m), and can greatly improve the biological yield.

The present application provides a method for planting high-yield forage in high altitude area, comprising the steps of:

intercropping maize and soybeans at an altitude of more than 3000 m in high altitude area, and the maize varieties includes Demeiya No. 1 and Demeiya No. 3, the soybean varieties include Zhongdou No. 39 and Huachun No. 6.

In some embodiments, the maize and soybeans are sown at the same time, and the sowing time is from the last ten days of April to the middle ten days of May every year.

In some embodiments, the planting density of the maize is 72000-75000 plants/hm².

In some embodiments, the planting density of the soybeans is 142500-150000 plants/hm².

In some embodiments, the intercropping includes with every 2 rows of maize as a belt intercropping a belt of soybean between every two belts of maize, and the number of soybean rows per belt is 3.

In some embodiments, the total width of the maize belt and the soybean belt is 210 cm.

In some embodiments, the row spacing of maize in each belt is 40 cm, the row spacing of soybean in each belt is 30 cm, and the distance between adjacent maize belts and soybean belts is 55 cm.

In some embodiments, the pit distance in each row of maize is 25 cm; the pit distance in each row of soybeans is 19 cm.

The application also provides a feed processing method based on the planting method described in the above technical schemes, which comprises the steps of: harvesting maize and soybeans at the same time to carry out mixed silage.

In some embodiments, the harvest time is from the middle ten days of September to the early ten days of October.

The application provides a method for planting high-yield forage in high altitude area. The traditional highland barley is generally planted in an area with an altitude of 2600 m-3300 m, and crops such as maize and wheat cannot mature normally in this area. The application can realize the successful planting of maize and soybeans in a high-altitude area (>3000 m), by using maize and soybean varieties suitable for planting in high altitude area, such as in Tibetan Plateau, and can greatly improve the biological yield, and the yield is as high as 58.35-67.8 t/hm², which is 2-3 times of the yield of traditional highland barley and oat, and can provide the winter and spring feed for 3-5 yaks. In addition, using the forage obtained by the planting method of the application to prepare silage can not only increase protein content, but also improve fermentation quality. The feed can provide energy and nutrition, and can significantly increase the crude protein content and calcium content of the silage, which is beneficial to the growth and development of yaks, and the daily weight gain of yak is increased by 40%. Specifically, in the comparative experiment of feeding yak, the daily weight gain based on the silage obtained by the application can be increased by 91.74% compared with the local hay. The planting and processing methods of the application (silage maize-silage soybean belt compound planting and mixed silage technology) demonstrated in plateau Tibetan areas can provide sufficient high-quality mixed silage for yaks in winter and spring and off-site rapid fattening, and increase the off-take rate and greatly reduce the overload pressure of yak to grassland.

### BRIEF DESCRIPTION OF THE DRAWINGS

FIG. 1 is a schematic diagram of maize/soybean belt (silage) planting mode of an embodiment.

### DETAILED DESCRIPTION OF THE EMBODIMENTS

The present application provides a method for planting high-yield forage in high altitude area, comprising the steps of:

Intercropping maize and soybeans at an altitude of more than 3000 m, and the varieties of maize include Demeiya No. 1 (It was introduced by KWS from Germany, the original code was KX7349; it was approved and promoted by Heilongjiang Variety Approval Committee in 2004) and Demeiya No. 3 (It was selected and bred by Beidahuang Kenfeng Seed Industry Co., Ltd., approved number: Heisen Jade 2013022), the varieties of soybeans include Zhongdou No. 39 (Provided by Oil Crops Research Institute, Chinese Academy of Agricultural Sciences) and Huachun No. 6 (Provided by South China Agricultural University). The selection of maize and soybean varieties in this application can achieve the successful cultivation of maize and soybeans in high-altitude areas and achieve high yields of maize and soybeans.

In the present application, the maize and soybeans are preferably sown at the same time, and the sowing time is preferably from the last ten days of April to the middle ten days of May every year. In the present application, the harvest time is preferably from the last ten days of September to the early ten days of October in the current year. Sowing too early, it is susceptible to freezing damage due to the low temperature; harvesting too late, it is seriously affected by frost, and thus affecting the quality.

In the present application, the planting density of the maize is preferably 7200˜75000 plants/hm². In the present application, the planting density of the soybeans is preferably 14250˜150000 plants/hm².

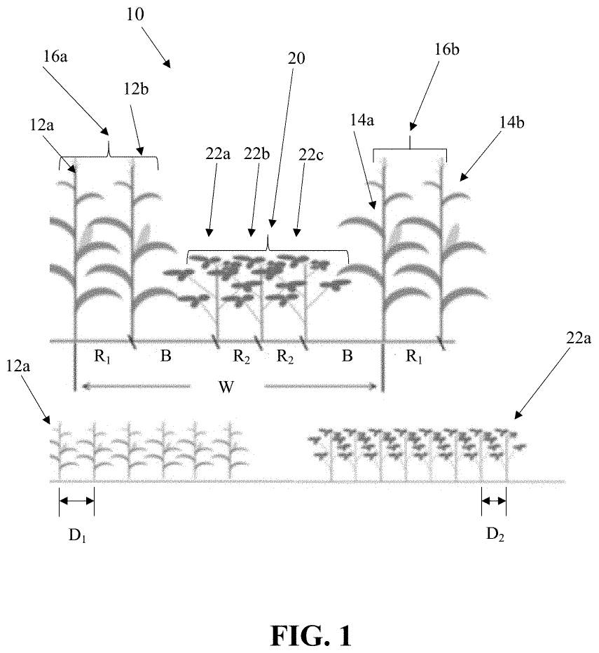

In the present application, and as shown in FIG. 1, the intercropping 10 preferably includes that with every 2 rows of maize 12a, 12b, 14a, 14b as a maize belt 16a, 16b intercrops a belt 20 of soybeans between every two belts 16a, 16b of maize, and the number of soybean rows 22a, 22b, 22c per soybean belt 20 is 3. In the present application, the total width “W” of the maize belt 16a, 20 and the soybean belt is preferably 210 cm. In the present application, the row spacing R₁ of maize in each belt is preferably 40 cm, the row spacing R₂ of soybeans in each belt is preferably 30 cm, and the distance “B” between adjacent maize belts 16a, 16b and soybean belts 20 is preferably 55 cm. In the present application, the maize pit distance D₁ in each row of maize is preferably 25 cm; the soybean pit distance D₂ in each row of soybeans is preferably 19 cm. In the present application, two plants are preferably planted per pit of maize or soybeans.

The present application also provides a feed processing method based on the planting method described in the above technical schemes, which comprises the steps of: harvesting maize and soybeans at the same time to carry out mixed silage. In the present application, the harvest time is preferably from the middle ten days of September to early ten days of October, and the present application is more preferably when the maize is in the milk ripe period (in the present application, only two varieties, Demaiya No. 1 or Demaiya No. 3, can enter the milk ripe period when they are harvested, and the rest of the varieties can not; in addition, due to the low temperature, delayed harvesting cannot lead to further maturation either, on the contrary, freezing damage will cause greater losses), simultaneous harvest of maize and soybeans. It is not conducive to the modulation of silage because of the low temperature in high altitude area, such as in Tibetan Plateau, so that hay is generally modulated. The processing of the feed obtained by the planting method of the present application can realize mixed silage of maize and soybeans, which not only improves protein content, but also improves fermentation quality; in addition, in the comparative experiment of feeding yak, the daily gain based on mixed feed can be increased by 91.74% compared with the local hay.

The method for planting high-yield forage in high altitude area according to the present application will be described in further detail with reference to specific embodiments. The technical solutions of the present application include but are not limited to the following embodiments.

### Example 1

The experimental site was Bamei Town, Kangding City, Ganzi Prefecture (altitude of 3450 m). Nine early maturing maize varieties (G504, G505, G415 (Provided by Heilongjiang Academy of Agricultural Sciences), KY17 (Provided by Heilongjiang Academy of Agricultural Sciences, variety code: Ke 956 Extension name KY 17), KY19 (Provided by Heilongjiang Academy of Agricultural Sciences, original code: 334, Variety name: KY 19), KF192, Heihe No. 45 (Provided by Heilongjiang Academy of Agricultural Sciences, verification/registration number: Hei Shendou 2007013), Demeiya No. 1, Demeiya No. 3), and 27 early maturing soybean varieties (Huachun No. 2, Huachun No. 6, Huachun No. 8, Huachun No. 14, Huachun No. 15 (All the Huachun soybean varieties were provided by South China Agricultural University), Zhongdou No. 30, Zhongdou No. 39, Zhongdou No. 46 (All the Zhongdou varieties were provided by Oil Crops Research Institute of Chinese Academy of Agricultural Sciences), Nandou No. 35 (Provided by Nanchong Academy of Agricultural Sciences, Sichuan Province), Nanchundou No. 31 (Provided by Nanchong Academy of Agricultural Sciences, Sichuan Province), Tianlong No. 2 (Provided by Oil Crops Research Institute, Chinese Academy of Agricultural Sciences), Nanchundou No. 37 (Provided by Nanchong Academy of Agricultural Sciences, Sichuan Province), Jiyu No. 251, Jiyu No. 257, Jiyu No. 260, Jiyu No. 259, Jiyu No. 299 (All the Jiyu varieties were provided by Jilin Academy of Agricultural Sciences), Qiandou No. 2 (Selected and bred by Guizhou Academy of Agricultural Sciences), Qiandou No. 3 (Selected and bred by Guizhou Academy of Agricultural Sciences), Fudou No. 7 (Provided by Maoxian Science, Technology, Agriculture and Livestock Bureau, Aba Prefecture, Sichuan Province), Jidou No. 12, Jidou No. 18, Ji of No. 37 (All the Jidou varieties were bred by Hebei Academy of Agricultural Sciences), Guixia No. 2 (Provided by South China Agricultural University), Yunhuang No. 12 (Provided by Yunnan Academy of Agricultural Sciences), Yunhuang No. 15 (Provided by Yunnan Academy of Agricultural Sciences), Tianlong No. 1 (Provided by Oil Crops Research Institute, Chinese Academy of Agricultural Sciences)) were used as the research materials. The planting density of maize was 75000 plants/hm², and the planting density of soybeans was 150000 plants/hm². The different maize varieties were arranged according to the field layout that maize and soybeans row ratio was 2:3 and the width of belt was 2.1 m (see FIG. 1 for details, maize row spacing was 40 cm, distance between soybeans and maize was 55 cm, soybean row spacing was 30 cm, and maize pit distance was 25 cm, the soybean pit distance was 19 cm, both of which were two plants per pit), one belt one variety, and the soybean varieties were planted in the intervals of maize belts. The fertilization of maize rows was carried out according to local production habits, and the nitrogen fertilization was not applied to soybean rows. Phosphorus and potassium fertilizers were consistent with local production levels. The experimental sowing was performed on May 15, 2018 and harvested on October 3.

At harvest, only Demeiya No. 1 and No. 3 maize would grow to the milk ripe stage, and the remaining varieties did not enter the grain filling stage; only soybean varieties of Huachun No. 6 and Zhongdou No. 39 were in the seed filling stage, and the remaining varieties had just podded or not; it can be seen from Table 1, that the highest yield of maize is Demeiya No. 1, followed by Demeiya No. 3; the highest yield of soybean was Huachun No. 6, followed by Zhongdou No. 39. It could be seen that the varieties screened by the present application could reach the appropriate harvesting period for the modulation of silage in the area with an altitude of 3500 m (maize was at milk ripe period and soybean was at seed filling stage), which could provide higher energy and protein required by yaks.

TABLE 1
Comparison of yield between different varieties of maize and soybean (t/hm²)

| maize | Biological | Soybean | Biological | Soybean | Biological | Soybean | Biological |
|---|---|---|---|---|---|---|---|
| varieties | yield | varieties | yield | varieties | yield | varieties | yield |
| G505 | 21.465 | Huachun | 0.990 | Zhongdou | 4.020 | Jiyu | 5.670 |
| | | No. 14 | | No. 46 | | No. 259 | |
| G504 | 22.800 | Zhongdou | 1.215 | Jidou | 4.290 | Jidou | 6.000 |
| | | No. 30 | | No. 12 | | No. 18 | |
| KY17 | 33.210 | Nanchundou | 2.745 | Guixia | 4.425 | Ji nf | 6.420 |
| | | No. 31 | | No. 2 | | No. 37 | |
| G415 | 34.680 | Tianlong | 2.925 | Huachun | 4.770 | Jiyu | 7.215 |
| | | No. 2 | | No. 15 | | No. 251 | |
| KF192 | 39.780 | Nanchundou | 3.105 | Huachun | 4.845 | Nandou | 7.440 |
| | | No. 37 | | No. 8 | | No. 35 | |
| KY19 | 42.555 | Jiyu | 3.150 | Yunhuang | 4.845 | Tianlong | 7.530 |
| | | No. 260 | | No. 12 | | No. 1 | |
| Heihe | 48.12 | Qiandou | 3.300 | Jiyu | 5.130 | Yunhuang | 8.070 |
| No. 45 | | No. 2 | | No. 299 | | No. 15 | |
| Demeiya | 50.535 | Qiandou | 3.660 | Jiyu | 5.235 | Zhongdou | 9.690 |
| No. 3 | | No. 3 | | No. 257 | | No. 39 | |
| Demeiya | 56.400 | Fudou | 3.780 | Huachun | 5.400 | Huachun | 10.560 |
| No. 1 | | No. 7 | | No. 2 | | No. 6 | |

### Example 2

The experimental site was Bamei Town, Kangding City, Ganzi Prefecture (altitude of 3450 m). Maize varieties were Demeiya No. 1 and No. 3; soybean varieties were Huachun No. 6 and Zhongdou No. 39. The planting density of maize was 7200˜75000 plants/hm², and the planting density of soybeans was 14250˜150000 plants/hm². The maize and soybeans were sown on Apr. 30, 2019 at a row ratio of 2:3 and a width of belt of 2.1 m. When the maize were in the milk ripe period, the maize and soybeans were harvested at the same time using a field integrated harvesting and shredder, and the silage was baled after the production was measured, and the nutritional quality of the silage was measured after 60 days of silage; at the same time, some maize and soybeans were harvested separately for baled silage, as comparison. The fertilization of maize rows was carried out according to local production habits, and the nitrogen fertilization was not applied to soybean rows. Phosphorus and potassium fertilizers were consistent with local production levels.

It can be seen from Table 2, that the intercropping biological yield of Demeiya No. 1 and No. 3 of maize and Huachun No. 6 or Zhongdou No. 39 of soybean at a 2:3 row ratio is 58.35-67.8 t/hm², which is far higher than that of conventional oat cultivation in Tibetan Plateau (Wang Huihui, Screening and Nutritional Value Evaluation of Oat Varieties in the Alpine Pastures of the Tibetan Plateau, Gansu Agricultural University Master Degree Thesis, p. 30, based on the dry matter content of 30%, the yield range of oats among different varieties is 27.3˜43.2 t/hm², and the altitude is 2494 m, with the increase of altitude, the yield will also decrease) and highland barley (Li Yuemei, the effect of fertilization on the output and economic benefits of highland barley in Menyuan District of Qinghai, Jiangsu Agricultural Science, the suitable altitude for highland barley planting is 2600˜3300 m, based on the dry matter content of 30%, the large-area output is 15.0˜19.95 t/hm²). The application realizes the cultivation of high-stalk crop maize in an area of an altitude close to 3500 m, and makes full use of the characteristics of sufficient light in the high altitude area to achieve a reasonable field configuration of maize and soybeans, and obtains a biological yield far higher than that of traditional barley and oats.

TABLE 2
Intercropping biological yield of maize and soybean

| | | | maize plants/hm² | | soybean plants/hm² | | measured | measured | biological |
|---|---|---|---|---|---|---|---|---|---|
| varieties | | re- | theoretical | actual | theoretical | actual | production | biological | yield |
| maize | soybean | peated | density | density | density | density | area | yield (kg) | (t/hm²) |
| Demaiya | Huachun | 1 | 75000 | 73500 | 150000 | 146700 | 8.4 m² | 56.95 | 67.80 |
| No. 1 | No. 6 | 2 | | 72750 | | 148800 | | 54.81 | 65.25 |
| | | 3 | | 73950 | | 147450 | | 56.45 | 67.20 |
| Demaiya | Zhongdou | 1 | | 73350 | | 143700 | | 54.05 | 64.35 |
| No. 1 | No. 39 | 2 | | 73020 | | 144750 | | 54.30 | 64.65 |
| | | 3 | | 73800 | | 145200 | | 54.56 | 64.95 |
| Demaiya | Huachun | 1 | | 72000 | | 146850 | | 52.67 | 62.70 |
| No. 3 | No. 6 | 2 | | 72750 | | 147300 | | 52.92 | 63.00 |
| | | 3 | | 73500 | | 149400 | | 53.55 | 63.75 |
| Demaiya | Zhongdou | 1 | | 72300 | | 142950 | | 49.01 | 58.35 |
| No. 3 | No. 39 | 2 | | 73500 | | 145200 | | 50.02 | 59.55 |
| | | 3 | | 72900 | | 145500 | | 50.27 | 59.85 |

TABLE 3
Characteristics of maize and soybean mixed silage as mixed raw materials

| | | | neutral detergent | acid detergent | Water soluble |
|---|---|---|---|---|---|
| | dry matter | crude protein | fiber NDF(% | fiber ADF(% | carbohydrate |
| treatment | DM(%) | CP(% DM) | DM) | DM) | WSC(% DM) |
| Demaiya No.1 | 34.38 | 7.21 | 36.94 | 21.03 | 19.97 |
| C1 | | | | | |
| Demaiya No.3 | 33.29 | 7.18 | 36.39 | 20.56 | 19.39 |
| C2 | | | | | |
| Huachun No. 6 | 28.73 | 15.52 | 47.41 | 29.67 | 4.59 |
| S1 | | | | | |
| Zhongdou | 27.98 | 15.17 | 47.94 | 31.39 | 4.83 |
| No. 39 S2 | | | | | |

It can be seen from Table 3 that the crude protein (CP) content, neutral detergent fiber (NDF) and acid detergent fiber (ADF) of soybean are significantly higher than that of maize, while the water soluble carbohydrate (WSC) content is significantly lower than that of maize, and the sugar content is lower than the minimum sugar content of 5% required for silage.

Fermentation quality: The fermentation quality of the silage directly reflects the success of the silage, which is more important than the nutrients. For conventional silage, there are three very important indexes for judging the success of silage, namely pH is less than 4.2, ammonia nitrogen/total nitrogen is less than 10%, and butyric acid content is less than 1%. It can be seen from Table 4 that the pH and butyric acid content of the silage soybean alone are not within the safe range, so the silage of soybean alone fails.

In the mixed silage of maize and soybeans, the pH, ammonia nitrogen/total nitrogen, lactic acid and butyric acid content had reached the standard of safe silage fermentation, and could be stored safely.

The pH value is usually regarded as an important index to evaluate the quality of the silage. It is generally believed that the requirement of successful silage can be achieved when the pH value is reduced to 4.2, and the pH value of soybeans after silage in this experiment is as high as 5.38, which is far from the acidic environment required for safe storage and utilization of silage. Ammonia nitrogen/total nitrogen is widely used to evaluate the quality of silage, which reflects the degree of protein decomposition during the silage process. The larger the value is, the more protein is decomposed, the worse the quality of the silage is. In this experiment, although the ammonia nitrogen/total nitrogen value after soybean silage was lower than 10%, it was much higher than that of silage of maize alone and the mixed silage of maize and soybeans, indicating that silage of soybean alone had more protein degradation. A successful silage should have higher lactic acid and lower butyric acid. Butyric acid is a kind of malodorous gas produced by the decomposition of glucose and lactic acid by Clostridium butyricum, which makes the raw materials odorous, thereby reducing the quality of silage. In this experiment, except for the silage of soybeans alone, the presence of butyric acid was not detected, and all of them had high lactic acid content, indicating that they have good fermentation quality and similar sensory quality conclusions.

TABLE 4
Fermentation quality under different storage
treatments of maize and soybean

| | | | | | pro- | | | |
|---|---|---|---|---|---|---|---|---|
| | | | lactic | acetic | pionic | butyric | | |
| | | Ammonia | acid | acid | acid | acid | | |
| | | nitrogen/ | (mg · | (mg · | (mg · | (mg · | | |
| treat- | | total | g⁻¹ | g⁻¹ | g⁻¹ | g⁻¹ | sense | |
| ment | pH | nitrogen | DM) | DM) | DM) | DM) | scores | grade |
| C1S1 | 4.11 | 3.79 | 6.03 | 1.13 | 0.83 | — | 18.34 | 1 |
| C1S2 | 4.08 | 3.46 | 6.02 | 1.27 | 0.84 | — | 18.65 | 1 |
| C2S1 | 4.16 | 3.82 | 6.01 | 1.29 | 0.85 | — | 18.33 | 1 |
| C2S2 | 4.09 | 3.78 | 6.11 | 1.68 | 0.89 | — | 18.56 | 1 |
| C1 | 4.18 | 3.91 | 6.98 | 1.37 | 1.12 | — | 18.45 | 1 |
| C2 | 4.12 | 3.81 | 7.02 | 1.35 | 1.06 | — | 18.67 | 1 |
| S1 | 5.38 | 7.19 | 1.41 | 4.95 | 2.08 | 1.59 | 3.28 | 4 |
| S2 | 5.15 | 7.21 | 1.43 | 4.93 | 2.02 | 1.43 | 2.98 | 4 |

Nutrient composition: it can be seen from Table 5, the content of CP, NDF and ADF in the silage of soybean alone are significantly higher than other treatments (P<0.05), and the content of WSC is significantly lower than other treatments (P<0.05). Maize has the highest WSC content and the lowest CP content in the silage alone, which is significantly different from other treatments (P<0.05). The CP content of mixed silage in each row is significantly higher than that of silage of maize alone (P<0.05).

The nutritional value of silage is a key problem that people pay attention to. The CP content is an important indicator to measure the nutritional value of forage. The whole plant of maize is easy to make silage, but the CP content is low, and the soybean CP content is high, but its WSC content is low, and the fermentation substrate is insufficient, which is not conducive to the success of the silage. However, the silage quality can be improved by the mixed silage of the two. In this experiment, after 60 days to obtain the silage of soybean alone, the WSC content was the lowest, while NDF and ADF were significantly the highest in all treatments. However, there is a negative correlation between NDF value and livestock absorption rate. The lower the NDF value is, the higher its economic value is. ADF is the indigestible part of cellulose, and its content is inversely related to the forage digestibility. These all indicate that soybean is not suitable for silage alone.

Compared with the silage of soybean alone, in the present application, maize has higher WSC content, which promotes the production of lactic acid and the rapid reduction of pH value, so that the fermentation reached an ideal state, and finally the silage was successful. However, the CP content of each treatment of the mixed silage of maize and soybeans was significantly higher than that of silage of maize alone, and the content of NDF and ADF was not significantly different from that of the silage of maize alone. This shows that although maize is easy to make silage, the addition of soybean is helpful to increase the crude protein content of the feed and further improve its quality.

TABLE 5
Nutritional composition of treatments under different mixed
silage of maize and soybeans

| | | | neutral | acid | |
|---|---|---|---|---|---|
| | dry | crude | detergent | detergent | Water soluble |
| treat- | matter | protein | fiber | fiber ADF(% | carbohydrate |
| ment | DM(%) | CP(% DM) | NDF(% DM) | DM) | WSC(% DM) |
| C1S1 | 33.29 | 10.35 | 36.05 | 21.21 | 4.35 |
| C1S2 | 33.16 | 10.19 | 36.09 | 21.15 | 4.32 |
| C2S1 | 32.18 | 10.28 | 35.97 | 21.32 | 4.40 |
| C2S2 | 32.09 | 9.98 | 35.82 | 21.26 | 4.47 |
| C1 | 33.88 | 6.21 | 35.98 | 21.09 | 4.51 |
| C2 | 32.69 | 6.09 | 35.87 | 20.76 | 4.29 |
| S1 | 23.63 | 13.68 | 45.21 | 28.99 | 1.21 |
| S2 | 22.07 | 13.09 | 45.35 | 30.09 | 1.23 |

### Example 3

The experimental site was Zake Township, Ganzi County (altitude of 3480 m). Maize varieties were Demeiya No. 1 and No. 3; soybean varieties were Huachun No. 6 and Zhongdou No. 39. The planting density of maize was 7200˜75000 plants/hm², and the planting density of soybeans was 14250˜150000 plants/hm². The maize and soybeans were sown on Apr. 28, 2019 at a row ratio of 2:3 and a width of belt of 2.1 m. When the maize were in the milk ripe period, the maize and soybeans were harvested at the same time using a field integrated harvesting and shredder, and the silage was baled after the production was measured, and the nutritional quality of the silage was measured after 60 days of silage; at the same time, some maize and soybeans were harvested separately for baled silage, as comparison. The fertilization of maize rows was carried out according to local production habits, and the nitrogen fertilization was not applied to soybean rows. Phosphorus and potassium fertilizers were consistent with local production levels.

It can be seen from Table 6, that the intercropping biological yield of Demeiya No. 1 and No. 3 of maize and Huachun No. 6 or Zhongdou No. 39 of soybean at a 2:3 row ratio is 59.25-67.65 t/hm², which is far higher than that of conventional oat cultivation in Tibetan Plateau and highland barley. It can be seen that the varieties selected by the present application can not only realize the cultivation of high-stalk crop maize and high-protein crop soybean in an area of an altitude close to 3500 m, and make full use of the characteristics of sufficient light in the high altitude area to achieve a reasonable field configuration of maize and soybean, and obtained a biological yield far higher than that of traditional barley and oats.

TABLE 6
Intercropping biological yield of maize and soybeans

| | | | | | soybean | | | | |
|---|---|---|---|---|---|---|---|---|---|
| | | | maize plants/hm² | | plants/hm² | | measured | measured | biological |
| varieties | | re- | theoretical | actual | theoretical | actual | production | biological | yield |
| maize | soybean | peated | density | density | density | density | area | yield (kg) | (t/hm²) |
| Demeiya | Huachun | 1 | 75000 | 73800 | 150000 | 149700 | 8.4 m² | 56.85 | 67.65 |
| No. 1 | No. 6 | 2 | | 72600 | | 149100 | | 54.71 | 65.10 |
| | | 3 | | 74100 | | 147900 | | 56.55 | 67.35 |
| Demeiya | Zhongdou | 1 | | 73200 | | 144000 | | 54.15 | 64.50 |
| No. 1 | No. 39 | 2 | | 73050 | | 144750 | | 54.25 | 64.65 |
| | | 3 | | 73800 | | 144900 | | 54.62 | 65.10 |
| Demeiya | Huachun | 1 | | 72150 | | 148350 | | 52.88 | 63.00 |
| No. 3 | No. 6 | 2 | | 72900 | | 147300 | | 52.96 | 63.00 |
| | | 3 | | 73350 | | 149550 | | 53.85 | 64.05 |
| Demeiya | Zhongdou | 1 | | 72600 | | 144450 | | 49.81 | 59.25 |
| No. 3 | No. 39 | 2 | | 73800 | | 144900 | | 50.22 | 59.85 |
| | | 3 | | 73200 | | 145650 | | 50.47 | 60.15 |

It can be seen from Table 7 that the crude protein (CP) content, neutral detergent fiber (NDF) and acid detergent fiber (ADF) of soybean are significantly higher than that of maize, while the water soluble carbohydrate (WSC) content is significantly lower than that of maize, and the sugar content is lower than the minimum sugar content of 5% required for silage.

TABLE 7
Characteristics of mixed raw materials of maize and soybean mixed silage

| | | | neutral detergent | acid detergent | Water soluble |
|---|---|---|---|---|---|
| | dry matter | crude protein | fiber NDF(% | fiber ADF(% | carbohydrate |
| treatment | DM(%) | CP(% DM) | DM) | DM) | WSC(% DM) |
| Demeiya No. 1 | 34.18 | 7.23 | 36.96 | 21.05 | 19.98 |
| C1 | | | | | |
| Demeiya No. 3 | 33.49 | 7.19 | 36.42 | 20.57 | 19.40 |
| C2 | | | | | |
| Huachun No. 6 | 28.77 | 15.51 | 47.39 | 29.65 | 4.49 |
| S1 | | | | | |
| Zhongdou No. | 27.94 | 15.27 | 47.84 | 31.41 | 4.63 |
| 39 S2 | | | | | |

Fermentation quality: it can be seen from table 8 that the pH (5.18 and 5.39) and butyric acid content (1.53 mg·g⁻¹DM and 1.61 mg·g⁻¹ DM) of silage of soybeans alone are not within the safe range in this experiment, resulting the fermentation quality lies only in the forth grade and fails to make silage. In the treatments for mixed silage of maize and soybean, the contents of pH, ammonia nitrogen/total nitrogen, lactic acid and butyric acid reached the standard of safe silage fermentation. The presence of butyric acid is not detected in all mixed silage treatments and all have high content of lactic acid, which indicated that they could be stored safely and have good fermentation quality; the sensory quality of each mixed silage treatment shows the similar conclusion that the fermentation quality reaches the first grade, and the silage is good.

TABLE 8
Fermentation quality under different storage
treatments of maize and soybean

| | | | | | pro- | | | |
|---|---|---|---|---|---|---|---|---|
| | | | lactic | acetic | pionic | butyric | | |
| | | Ammonia | acid | acid | acid | acid | | |
| | | nitrogen/ | (mg · | (mg · | (mg · | (mg · | | |
| treat- | | total | g⁻¹ | g⁻¹ | g⁻¹ | g⁻¹ | sense | |
| ment | pH | nitrogen | DM) | DM) | DM) | DM) | scores | grade |
| C1S1 | 4.06 | 3.69 | 6.13 | 1.14 | 0.82 | — | 18.24 | 1 |
| C1S2 | 4.07 | 3.47 | 6.12 | 1.26 | 0.83 | — | 18.45 | 1 |
| C2S1 | 4.06 | 3.78 | 6.11 | 1.28 | 0.84 | — | 18.36 | 1 |
| C2S2 | 4.09 | 3.76 | 6.18 | 1.68 | 0.86 | — | 18.58 | 1 |
| C1 | 4.11 | 3.81 | 6.78 | 1.36 | 1.08 | — | 18.48 | 1 |
| C2 | 4.09 | 3.71 | 6.82 | 1.34 | 1.09 | — | 18.77 | 1 |
| S1 | 5.39 | 7.29 | 1.42 | 4.94 | 2.06 | 1.61 | 3.18 | 4 |
| S2 | 5.18 | 7.28 | 1.41 | 4.95 | 2.01 | 1.53 | 2.99 | 4 |

Nutrient composition: it can be seen from Table 9, the content of CP, NDF and ADF in soybean silage alone are significantly higher than other treatments (P<0.05), and the content of WSC is significantly lower than other treatments (P<0.05). Maize has the highest WSC content and the lowest CP content in the silage alone, which is significantly different from other treatments (P<0.05). The CP content of mixed silage at each row ratio is significantly higher than that in silage of maize alone (P<0.05), however, the content of NDF and ADF is not significantly different from that of silage of maize alone (P<0.05).

Similar to the conclusion of Example 2, this example also shows once again that mixed silage can combine the characteristics of high CP content of soybean and high WSC content of maize, make up for the deficiencies of silage of each alone, so as to maximize the improvement of the nutritional quality of silage, and achieve the effect where 1+1 is greater than 2.

TABLE 9
Nutritional composition of treatments under different mixed
silage of maize and soybeans

| | | | neutral | acid | |
|---|---|---|---|---|---|
| | dry | crude | detergent | detergent | Water soluble |
| treat- | matter | protein | fiber | fiber ADF(% | carbohydrate |
| ment | DM(%) | CP(% DM) | NDF(% DM) | DM) | WSC(% DM) |
| C1S1 | 33.19 | 10.36 | 36.04 | 21.20 | 4.34 |
| C1S2 | 33.17 | 10.21 | 36.08 | 21.16 | 4.33 |
| C2S1 | 32.19 | 10.29 | 35.96 | 21.33 | 4.39 |
| C2S2 | 32.13 | 9.99 | 35.81 | 21.27 | 4.46 |
| C1 | 33.87 | 6.23 | 35.96 | 21.11 | 4.50 |
| C2 | 32.66 | 6.13 | 35.86 | 20.78 | 4.28 |
| S1 | 23.62 | 13.69 | 45.19 | 28.98 | 1.22 |
| S2 | 22.06 | 13.14 | 45.25 | 30.08 | 1.24 |

### Example 4

This experiment was conducted at Guogan Farm in Kangding County, Ganzi Prefecture, Sichuan Province from Oct. 1, 2018 to Dec. 29, 2018, for a total of 90 days.

Forty yaks with similar weight from growth and development and good health were selected and randomly divided into 2 groups with 20 Yaks in each group. The control group (CK) was fed with traditionally provided feed, and the experimental group with an equivalent amount of silage to replace the hay in the traditional feeding composition, as shown in Table 10. It can be seen from Table 11 that in the comparative experiment of feeding yak, the average daily weight gain based on mixed feed compared to local hay can be increased by 91.74%. This indicates that mixed silage of maize and soybeans can increase the average daily gain of yak, facilitate the rapid growth thereof, and improve feed conversion rate.

TABLE 10
Diet composition of yak in winter (g/head/D)

| | The | |
|---|---|---|
| | control | Maize |
| Diet species | group | silage |
| oat hay | 15000 | |
| Maize and | | 15000 |
| soybean silage | | |
| corn meal | 2100 | 500 |
| soybean meal | 350 | 350 |
| soda | 35 | 35 |
| wheat bran | 175 | 175 |
| salt | 35 | 35 |

TABLE 11
Changes in body weight of experimental yak

| | | Average | Average | Average | Average | | |
|---|---|---|---|---|---|---|---|
| | | starting | final | weight | daily | | |
| | | weight | weight | gain | gain | | |
| | | (kg) | (kg) | (kg) | (g/d) | starting date | ending date |
| yak | traditional | 50 | 98 | 48 | 533 | September 1 | December 1 |
| | feeding | | | | | | |
| | maize and | 50 | 142 | 92 | 1022 | September 1 | December 1 |
| | soybean mixed | | | | | | |
| | silage | | | | | | |

The above described are only preferred embodiments of the present application, it should be understood by those skilled in the art that, without departing from the principle of the present application, several improvements and retouches can be made, and these improvements and retouches also should be regarded as the protection scope of the present application fall into the scope of the present application.

1. A method for planting high-yield forage in a high altitude area, comprising the steps of:
intercropping maize and soybeans at an altitude of more than 3000 m, wherein the maize is selected from Demeiya No. 1 and Demeiya No. 3, and the soybeans are selected from Zhongdou No. 39 and Huachun No. 6.

2. The method for planting according to claim 1, including sowing the maize and soybeans at the same time, within a sowing period from the last ten days of April to the middle ten days of May.

3. The method for planting according to claim 1, wherein a planting density of the maize is 72000-75000 plants/hm².

4. The method for planting according to claim 1, wherein a planting density of the soybeans is 142500150000 plants/hm².

5. The method for planting according to claim 1, wherein the intercropping includes with every two rows of maize as a maize belt intercropping a soybean belt between every two adjacent maize belts, wherein each soybean belt includes three soybean rows.

6. The method for planting according to claim 5, wherein the total width of one of the maize belts and the soybean belt is 210 cm.

7. The method for planting according to claim 5, wherein a row spacing of maize in each maize belt is 40 cm, a row spacing of soybeans in each soybean belt is 30 cm, and a distance between adjacent maize belts and soybean belts is 55 cm.

8. The method for planting according to claim 5, wherein a maize pit distance in each row of maize is 25 cm; and a soybean pit distance in each row of soybeans is 19 cm.

9-16. (canceled)
